(19) United States
(12) Patent Application Publication
(10) Pub. No.: US 2017/0063858 A1
(43) Pub. Date: Mar. 2, 2017

(54) Alertness Based Authorization

(71) Applicant: CA, Inc., New York, NY (US)

(72) Inventors: Sreenivasulu Bandi, SERILINGAMPALLY (IN); Ragavendran Padmanabhan, KPHB COLONY (IN); John Ainsworth, Mount Sinai, NY (US); Shaik Mokhinuddeen, HYDERABAD (IN)

(21) Appl. No.: 14/840,182

(22) Filed: Aug. 31, 2015

(51) Int. Cl. H04L 29/06

(52) U.S. Cl. CPC H04L 63/10; H04L 63/08

(57) ABSTRACT

Various methods, apparatus, computer program products embodied on computer-readable storage mediums, and systems of providing alertness-based authorization include determining the alertness of a user and authorizing access permissions for that user based on the determined alertness. Although the user is associated with access permissions that are predefined, the access permissions actually authorized for that user are distinct from the predefined access permissions with which the user is associated.

### BACKGROUND

The present disclosure relates to various methods, devices, computer program products, and systems of providing alertness-based authorization, and in particular, determining the alertness of a user and authorizing access permissions for the user based on the determined alertness.

### BRIEF SUMMARY

The present disclosure provides methods, apparatus, computer program products embodied on computer-readable storage mediums, and systems of providing alertness-based authorization. In particular, embodiments of the present disclosure will determine the alertness of a user and authorize access permissions for that user based on the determined alertness.

In one embodiment, a computer-implemented method comprises receiving an access request from a user associated with predefined access permissions, determining an alertness score corresponding to the access request based on a test administered to the user, and authorizing access permissions for the user based on the alertness score. In particular, the authorized access permissions are distinct from the predefined access permissions.

In another embodiment, a computing device comprises interface circuitry and processing circuitry that is communicatively coupled to the processing circuitry. The interface circuitry is configured to exchange signals with a user. The processing circuitry is configured to receive an access request from the user associated with predefined access permissions via the interface circuitry, determine an alertness score corresponding to the access request based on a test administered to the user via the interface circuitry, and authorize access permissions for the user based on the alertness score. In particular, the authorized access permissions are distinct from the predefined access permissions.

In a further embodiment, a computer-readable storage medium comprises executable code stored thereon. When the executable code is executed by processing circuitry of a computing device, the computing device is configured to receive an access request from a user associated with predefined access permissions, determine an alertness score corresponding to the access request based on a test administered to the user, and authorize access permissions for the user based on the alertness score. In particular, the authorized access permissions are distinct from the predefined access permissions.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating an example system in which users access a computing device that provides alertness-based authentication, according to various embodiments of the present disclosure.

FIG. 2 illustrates an example interface for testing the alertness of a user, according to various embodiments of the present disclosure.

FIG. 3 is a table that illustrates an example scheme in which access permissions authorized for a user are based on an alertness score determined for the user, according to various embodiments of the present disclosure.

FIG. 4 is a flow diagram illustrating an example method of providing alertness-based authentication, according to various embodiments of the present disclosure.

FIG. 5 is a flow diagram illustrating a more detailed example method of providing alertness-based authentication, according to various embodiments of the present disclosure.

FIG. 6 is a flow diagram illustrating a further detailed example method of providing alertness-based authentication, according to various embodiments of the present disclosure.

FIG. 7 is a block diagram illustrating example hardware of a computing device that provides alertness-based authentication, according to various embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or combining software and hardware implementation that may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Accordingly, the present disclosure provides methods, apparatus, computer program products embodied on computer-readable storage mediums, and systems of providing alertness-based authorization. In particular, embodiments of the present disclosure will determine the alertness of a user and authorize access permissions for that user based on the determined alertness.

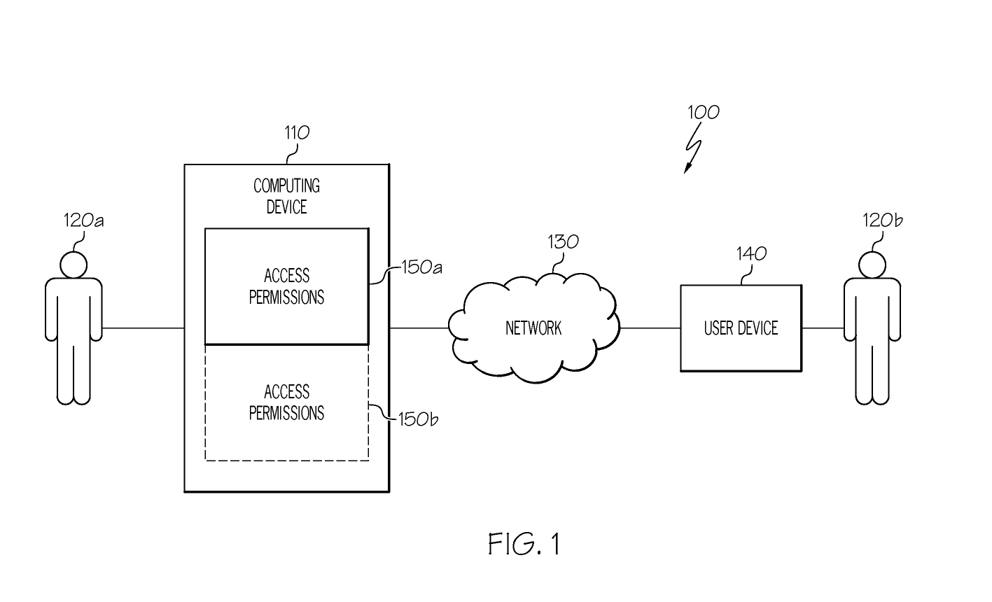

Turning to the drawings, FIG. 1 illustrates an example system 100 according to embodiments of the present disclosure. The example system 100 comprises a computing device 110, network 130, and user device 140. The example system 100 supports multiple users 120, including local user 120a, and remote user 120b. Note that, as used herein, when a reference numeral comprises a letter designation in the drawings, discussion of a specific instance of an illustrated element will use the appropriate corresponding letter designation (e.g., local user 120a). However, the letter designation will be omitted in order to refer generically to the illustrated subject matter (e.g., discussion of a user 120 (generally), rather than discussion of particular users 120a, 120b).

The computing device 110 may be any device that is capable of electronically interfacing with a user 120. Examples of the computing device 110 include a personal computer, desktop computer, laptop computer, workstation, smartphone, wearable computer, tablet computer, server, or server cluster. For example, the computing device 110 may comprise a keyboard, mouse, and display for direct use by local user 120a.

Alternatively, the computing device 110 may lack a keyboard, mouse, and display, but be capable of electronically interfacing with a remote user 120b by exchanging communication signals with user device 140 via the network 130. The network 130 may be any network capable of carrying communication signals between the user device 140 and computing device 110. Examples of the network 130 include (but are not limited to) one or more of the Internet, one or more local area networks, one or more wireless networks, one or more cellular networks, one or more Internet Protocol-based networks, one or more Ethernet networks, one or more optical networks, and one or more circuit switched networks. The user device 140 may be any device that is capable of exchanging communication signals with the computing device 110 over the network 130, and capable of interfacing with a local human operator acting as a remote user 120b of the computing device 110. For example, remote user 120b may use a laptop computer to interface with the computing device 110 via the Internet. Other examples of a user device 140 include a personal computer, desktop computer, workstation, smartphone, wearable computer, or tablet computer.

Although the computing device 110 illustrated as part of the example system 100 is capable of electronically interfacing with both local user 120a and remote user 120b, embodiments of the computing device 110 need not support both local and remote users. Further, embodiments of the present disclosure include an example system 100 that supports only a single user 120.

The computing device 110 associates users 120 with predefined access permissions 150. For example, local user 120a may be assigned predefined access permissions 150a, and remote user 120b may be assigned predefined access permissions 150b. Thus, each user 120 using the system 100 may be assigned predefined access permissions 150 that are unique to that user.

In an alternate embodiment, both users 120a, 120b, may be assigned predefined access permissions 150a. Thus, according to such alternate embodiments, multiple users 120 may be assigned the same predefined access permissions 150.

The predefined access permissions 150 define the authority that each associated user 120 is assigned for accessing certain computing resources. The computing resources associated with these predefined access permissions 150 may be located on the computing device 110, and/or may be connected to the computing device 110 via the network 130. Examples of computing resources include, but are not limited to, software services, documents, computers, routers, and networks. Thus, for example, local user 120a may be associated with predefined access permissions 150a which, if authorized, would allow local user 120a to access files on the computing device 110 as well as access the network 130. Further, remote user 120b may be associated with predefined access permissions 150b which, if authorized, would allow remote user 120b access to the network 130 but not to the files on the computing device 110. As previously mentioned, and as will be discussed in greater detail below, the access permissions that are actually authorized will be based, at least in part, on user alertness.

Although various embodiments include unique access permissions that are predefined for a very large number of users 120, predefined access permissions 150 may alternatively be managed by associating those permissions with corresponding predefined access roles. A predefined access role may then be assigned to one or more users 120 in order to associate those users 120 with the corresponding permissions. For example, an “administrator” access role may be predefined for any number of users 120, such that each user 120 associated with the administrator role is assigned full access to all computing resources on the computing device 110. Such full access may include, for example, creating, reading, writing, and deleting files, installing, executing, and uninstalling software, and so on. For another example, a “tenant admin” access role may be predefined for any number of users 120, such that each user 120 associated with the tenant admin role is assigned full access to only a portion of the computing resources on the computing device 110. Thus, a user 120 associated with a tenant admin role may be assigned full access to files in the same way as described above for an administrator, but may not be assigned access to installing or uninstalling software. As a yet further example, an “end user” access role may be predefined for any number of users 120, such that each user 120 associated with the end user access role is assigned only limited access to the computing resources on the computing device 110. For example, a user 120 associated with the end user access role may only be assigned access to read files and execute software. Other roles in addition to, or instead of, the above examples may be predefined, according to various embodiments.

Although a particular user (e.g., local user 120a) may be associated with particular predefined access permissions (e.g., predefined access permissions 150a), circumstances may arise in which it may be unwise to actually authorize predefined access permissions 150a for local user 120a. For example, local user 120a may be assigned the above-mentioned administrator role, and therefore be assigned access to all of the files on computing device 110. However, on any particular day, that local user 120a may be extremely tired, distracted, or even drunk. In such situations, local user 120a may be prone to making errors that might jeopardize the security of those files, e.g., by accidentally deleting them. Thus, as previously mentioned, the access permissions that the computing device 110 authorizes for a user 120 are based on the alertness of that user 120, which may be distinct from the predefined access permissions 150 with which that user 120 is associated. As used herein, predefined access permissions 150 and authorized access permissions are distinct if either provides greater, lesser, or different access permissions to computing resources in view of the other.

To determine the alertness of a user 120, a test may be administered to the user 120 in response to, or as part of, an access request that the computing device 110 receives from the user 120. For example, a user 120 may be required to provide the computing device 110 with their credentials as part of a request to access certain computing resources, as described above. These credentials may include a username, a password, a digital certificate, and any other information by which the computing device 110 may verify the identity of the user 120. The user 120 may be tested within the same interface in which the user 120 provides the required credentials.

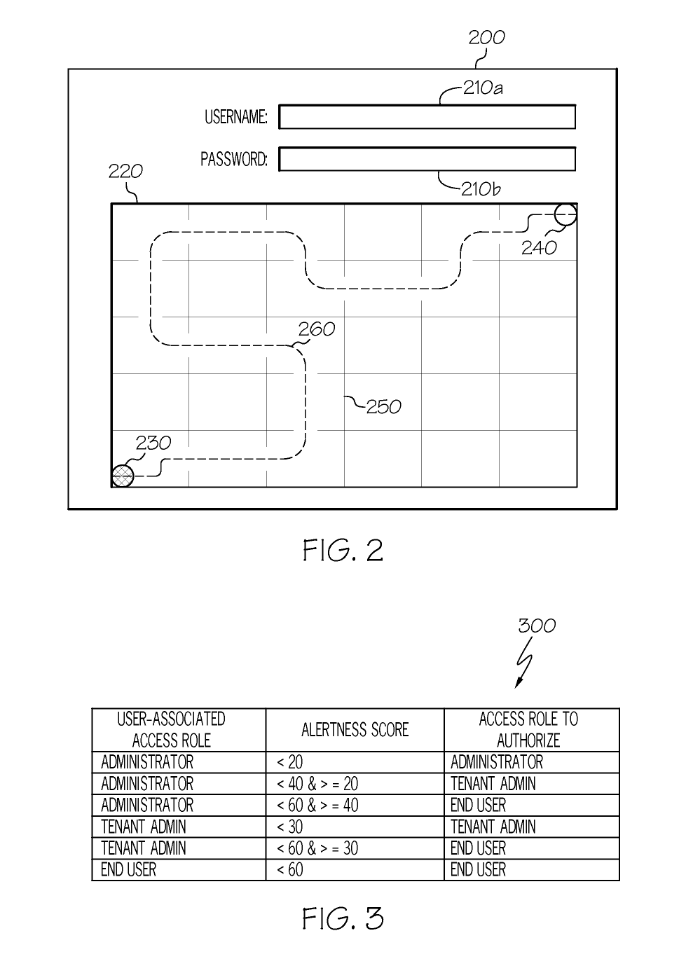

FIG. 2 illustrates an example interface 200 for testing the alertness of a user 120. The example interface 200 comprises text-entry fields 210a, 210b into which the user 120 is expected to enter their username and password, respectively. The example interface 200 also comprises a test 220 that is administered to the user 120 in the form of a skill-based game. In this example, the user 120 must play the game in order to submit their username and password in a request for access to the computing device 110. In this particular skill-based game, the user 120 is expected to provide appropriate input to move an icon 230 (represented in FIG. 2 as a black ball) through a maze along a path 260 and to a goal 240, without touching any walls 250 of the maze or backtracking. Completion of the game by the user 120 produces an alertness score based on how well the user 120 performed while playing the skill-based game.

The alertness score may take many forms, depending on embodiments. For example, the alertness score may be based on a time required by the user 120 to complete the test 220. The alertness score may additionally or alternatively be based on the extent to which the test 220 is correctly completed by the user 120. In considering the extent to which the test 220 is correctly completed by the user 120, the number of errors committed by the user 120 may negatively impact the alertness score, for example.

FIG. 3 is a table that illustrates an example scheme 300 in which the access permissions authorized for a user 120 is based on an alertness score determined for the user 120. According to the example scheme 300, users 120 are initially associated with predefined access roles, as previously discussed. The alertness score corresponds to a number of seconds a particular user 120 needs to complete an administered test 220. The computing device 110 will authorize access permissions 150 that correspond to a predefined access role that is selected, based on the alertness score, from a plurality of predefined access roles.

For example, a user 120 that is initially associated with an administrator role will be authorized for predefined access permissions 150 that correspond to that administrator role only if the alertness score corresponding to that user's access request is less than 20 seconds. If the alertness score corresponding to the user's access request is not less than 20 seconds, but is less than 40 seconds, then predefined access permissions 150 corresponding to a tenant admin role is authorized by the computing device 110, even though the user is initially associated with the administrator role (and not associated with the tenant admin role). If the alertness score corresponding to the user's access request is not less than 40 seconds, but is less than 60 seconds, then access permissions 150 corresponding to an end user role is authorized by the computing device 110. If the alertness score corresponding to the user's access request is not less than 60 seconds, then access permissions are not authorized by the computing device 110.

Thus, according to this example scheme 300, authorizing access permissions 150 for the user 120 based on the alertness score comprises authorizing access permissions 150 for the user 120 that are more limited than the predefined access permissions 150 with which the user 120 is initially associated, e.g., for certain ranges of alertness scores. Further, according to the example scheme 300, users 120 that are associated with other predefined access roles (i.e., tenant admin or end user) are classified for authorization purposes according to ranges other than those applied to users 120 associated with the administrator role.

Other embodiments of the present disclosure may use other schemes for authorizing access permissions based on an alertness score determined for the user 120. For example, according to one or more embodiments, authorizing access permissions for the user 120 based on the alertness score comprises authorizing a modification of the predefined access permissions 150 associated with the user 120. For example, a user 120 may be initially associated with predefined access permissions 150 that permit the user 120 to read and write files on the computing device 110, yet based on the alertness score, the computing device 110 may instead authorize the user 120 to only read files on the computing device 110, or to also delete files on the computing device 110.

Although the access permissions that are authorized by the computing device 110 under the example scheme 300 of FIG. 3 is based on the alertness score falling within fixed ranges, the access permissions that are authorized by the computing device 110 may additionally or alternatively be based on how the alertness score compares to a historical testing record of the user 120 obtained from previous tests 220. For example, if a particular user 120 has a historical average test completion time of 30 seconds, but the alertness score corresponding to the user's access request is more than one standard deviation above the historical average test completion time, the computing device 110 may authorize access permissions for the user 120 that are distinct from the predefined access permissions 150 with which the user 120 is associated.

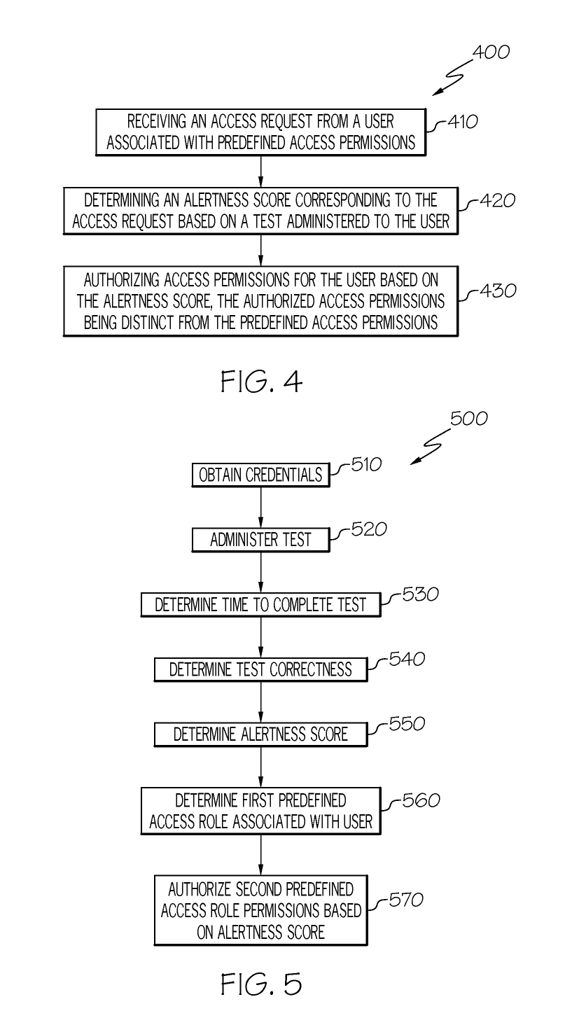

Thus, in accordance with various embodiments of the present disclosure, FIG. 4 illustrates an example method 400, implemented by a computing device 110. The example method 400 comprises receiving an access request from a user 120 associated with predefined access permissions 150 (block 410), determining an alertness score corresponding to the access request based on a test 220 administered to the user 120 (block 420), and authorizing access permissions 150 for the user 120 based on the alertness score (block 430). In particular, the authorized access permissions are distinct from the predefined access permissions 150. Thus, the authorized access permissions may provide greater, fewer, or different access permissions to computing resources than the predefined access permissions 150 with which the user 120 is associated, as previously discussed.

FIG. 5 illustrates a more detailed method 500, implemented by a computing device 110, according to various embodiments. The method 500 comprises obtaining credentials as part of an access request from the user 120 (block 510), and administering a test 220 to the user 120 in response (block 520). For example, the method 500 may comprise administering the skill-based test 220 illustrated in FIG. 2. The method 500 further comprises determining a time required by the user 120 to complete the test 220 (block 530) and determining an extent to which the test 220 is correctly completed by the user 120 (block 540). For example, the method 500 may comprise determining that the user took 40 seconds to complete the test 220, and determining that the user bumped into maze walls 250 five times before the test 220 was completed. The determined time and correctness are then both used to determine an alertness score corresponding to the access request (block 550). The method 500 further comprises determining a first predefined access role associated with the user 120 (block 560), and based on the alertness score, authorizing access permissions associated with a second predefined access role (block 570). In particular, the first and second predefined access roles are distinct, according to the method 500.

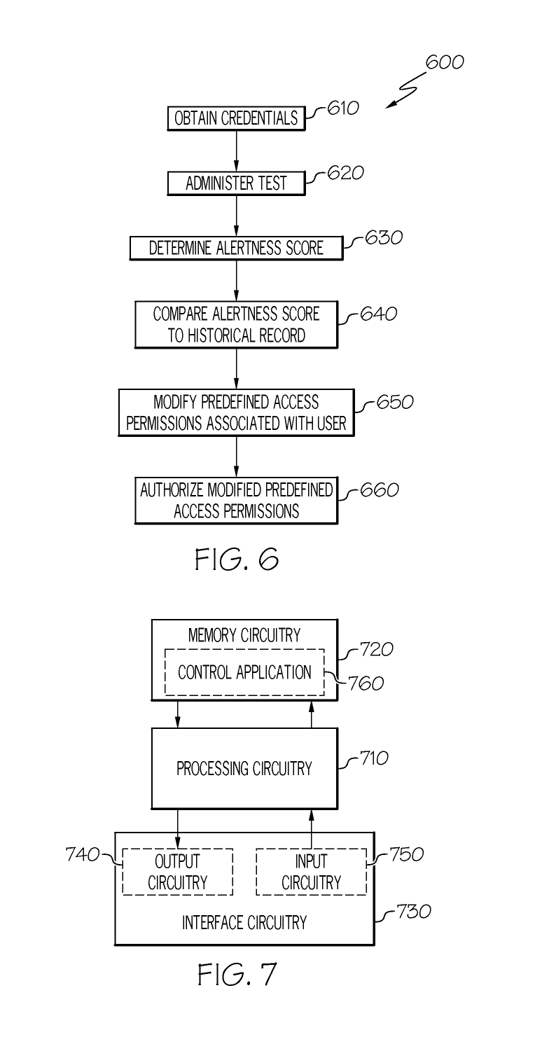

FIG. 6 illustrates another detailed method 600, implemented by a computing device 110, according to various embodiments. The method 600 comprises obtaining credentials as part of an access request from the user 120 (block 610), administering a test 220 to the user 120 (block 620), and based on the results of the test 220, determining an alertness score corresponding to the access request (block 630). The method 600 further comprises comparing the alertness score to a historical testing record of the user 120 obtained from testing the user 120 previous to receiving the access request (block 640). The method 600 further comprises modifying predefined access permissions 150 that are associated with the user 120 (block 650) and authorizing those modified access permissions modified for the user 120 (block 660).

The computing device 110 may be implemented according to the example hardware illustrated in FIG. 7. The example hardware of FIG. 7 comprises processing circuitry 710, memory circuitry 720, and interface circuitry 730. The processing circuitry 710 is communicatively coupled to the memory circuitry 720 and interface circuitry 730, e.g., via one or more buses. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing machine instructions stored as a machine-readable computer program 760 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the computing device 110. Such I/O data paths may include data paths for exchanging signals over a communications network 130 and/or data paths for exchanging signals with a user 120. For example, the interface circuitry 730 may comprise a transceiver configured to send and receive communication signals over one or more of a cellular network, Ethernet network, or optical network. The interface circuitry 730 may also comprise one or more of a graphics adapter, display port, video bus, touchscreen, graphical processing unit (GPU), display port, Liquid Crystal Display (LCD), and Light Emitting Diode (LED) display, for presenting visual information to a user 120. The interface circuitry 730 may also comprise one or more of a pointing device (such as a mouse, stylus, touchpad, trackball, pointing stick, joystick), touchscreen, microphone for speech input, optical sensor for optical recognition of gestures, and keyboard for text entry.

The interface circuitry 730 may also comprise input circuitry 750 and output circuitry 740. For example, the output circuitry 740 may comprise a transmitter configured to send communication signals over the communications network 130, whereas the input circuitry 750 may comprise a receiver configured to receive communication signals over the communications network 130. Thus, the interface circuitry 730 may be implemented as a unitary physical component, or as a plurality of physical components that may be contiguously or separately arranged, any of which may be communicatively coupled to any other, or may communicate with any other via the processing circuitry 710. Similarly, the output circuitry 740 may comprise a display, whereas the input circuitry 750 may comprise a keyboard. Other examples, permutations, and arrangements of the above and its equivalents will be readily apparent to those of ordinary skill.

The processing circuitry 710 may be configured to receive an access request from the user 120 associated with predefined access permissions 150 via the interface circuitry 730, determine an alertness score corresponding to the access request based on a test 220 administered to the user 120 via the interface circuitry 730, and authorize access permissions 150 for the user 120 based on the alertness score (the authorized access permissions 150 being distinct from the predefined access permissions 150).

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method comprising:
receiving an access request from a user associated with predefined access permissions;
determining an alertness score corresponding to the access request based on a test administered to the user;
authorizing access permissions for the user based on the alertness score, the authorized access permissions being distinct from the predefined access permissions.

2. The method of claim 1, further comprising authenticating the user based on credentials received in the access request.

3. The method of claim 1, wherein determining the alertness score corresponding to the access request based on the test administered to the user comprises administering a skill-based game, to the user, that produces the alertness score.

4. The method of claim 1, wherein authorizing access permissions for the user based on the alertness score comprises authorizing a modification of the predefined access permissions.

5. The method of claim 1:
wherein the predefined access permissions correspond to a first predefined access role;
wherein authorizing access permissions for the user based on the alertness score comprises authorizing access permissions that correspond to a second predefined access role that is distinct from the first predefined access role.

6. The method of claim 5, wherein authorizing access permissions that correspond to the second predefined access role comprises selecting, based on the alertness score, the second predefined access role from a plurality of other predefined access roles that are distinct from the first predefined access role.

7. The method of claim 1, wherein authorizing access permissions for the user based on the alertness score comprises authorizing access permissions for the user that are more limited than the predefined access permissions.

8. The method of claim 1, wherein authorizing access permissions for the user based on the alertness score comprises comparing the alertness score to a historical testing record of the user obtained from testing the user previous to receiving the access request.

9. The method of claim 1, wherein determining the alertness score corresponding to the access request based on the test administered to the user comprises determining a time required by the user to complete the test administered to the user.

10. The method of claim 1, wherein determining the alertness score corresponding to the access request based on the test administered to the user comprises determining an extent to which the test is correctly completed by the user.

11. A computing device comprising:
interface circuitry configured to exchange signals with a user;
processing circuitry communicatively coupled to the interface circuitry and configured to:
receive an access request from the user associated with predefined access permissions via the interface circuitry;
determine an alertness score corresponding to the access request based on a test administered to the user via the interface circuitry;
authorize access permissions for the user based on the alertness score, the authorized access permissions being distinct from the predefined access permissions.

12. The computing device of claim 11, wherein the processing circuitry is further configured to authenticate the user based on credentials received in the access request.

13. The computing device of claim 11, wherein to determine the alertness score corresponding to the access request based on the test administered to the user via the interface circuitry, the processing circuitry is configured to administer a skill-based game, to the user via the interface circuitry, that produces the alertness score.

14. The computing device of claim 11, wherein to authorize access permissions for the user based on the alertness score the processing circuitry is configured to authorize a modification of the predefined access permissions.

15. The computing device of claim 11:
wherein the predefined access permissions correspond to a first predefined access role;
wherein to authorize access permissions for the user based on the alertness score the processing circuitry is configured to authorize access permissions that correspond to a second predefined access role that is distinct from the first predefined access role.

16. The computing device of claim 15, wherein to authorize access permissions that correspond to the second predefined access role the processing circuitry is configured to select, based on the alertness score, the second predefined access role from a plurality of other predefined access roles that are distinct from the first predefined access role.

17. The computing device of claim 11, wherein to authorize access permissions for the user based on the alertness score the processing circuitry is configured to authorize access permissions for the user that are more limited than the predefined access permissions.

18. The computing device of claim 11, wherein to authorize access permissions for the user based on the alertness score the processing circuitry is configured to compare the alertness score to a historical testing record of the user obtained from testing the user previous to receiving the access request.

19. The computing device of claim 11, wherein to determine the alertness score corresponding to the access request based on the test administered to the user via the interface circuitry, the processing circuitry is configured to determine a time required by the user to complete the test administered to the user.

20. The computing device of claim 11, wherein to determine the alertness score corresponding to the access request based on the test administered to the user via the interface circuitry, the processing circuitry is configured to determine an extent to which the test is correctly completed by the user.

21. A computer-readable storage medium comprising executable code stored thereon that, when executed by processing circuitry of a computing device, configures the computing device to:
receive an access request from a user associated with predefined access permissions;
determine an alertness score corresponding to the access request based on a test administered to the user;
authorize access permissions for the user based on the alertness score, the authorized access permissions being distinct from the predefined access permissions.
